(19) United States
(12) Patent Application Publication
(10) Pub. No.: US 2023/0306324 A1
(43) Pub. Date: Sep. 28, 2023

(54) ARTIFICIAL INTELLIGENCE-BASED TASK ASSIGNMENT ASSISTANT IN MULTIPARTICIPANT MESSAGE EXCHANGES

(71) Applicant: International Business Machines Corporation, Armonk, NY (US)

(72) Inventors: Jonathan Terner, Beacon, NY (US); Rodolfo Lopez, Austin, TX (US); Gandhi Sivakumar, Bentleigh (AU); Ricardo Daniel Zamora Ruvalcaba, Tlaquepaque (MX)

(21) Appl. No.: 17/656,355

(22) Filed: Mar. 24, 2022

(51) Int. Cl. G06Q 10/06; G06F 16/2457

(52) U.S. Cl. CPC G06Q 10/06311; G06F 16/24578

(57) ABSTRACT

Automatic task assignment in a multiparticipant message exchange includes receiving, by a computer, data snapshots from a collaborative message exchange between one or more participants. Based on the data snapshots, the computer identifies tasks requiring completion, a task leader among participants, and a task criteria. Based on a semantic match between the task criteria and a database of historical task completion, the computer identifies a candidate pool for completing the tasks and determines a likelihood of each candidate completing the tasks. A relevancy score is assigned based on the likelihood and used to generate a list of ranked candidates for completing the tasks. The computer presents the list to the task leader, receives a selection from the task leader including at least one candidate for completing the tasks, automatically notifies the selected candidate of the tasks to be completed, and updates the database of historical task completion.

### BACKGROUND

The present invention generally relates to the field of contextual collaboration and interaction, and more particularly to an artificial intelligence-based task assignment assistant for identifying and assigning tasks generated during a multiparticipant message exchange session.

Collaborative messaging systems have become widely adopted across both work and personal environments. Currently, many organizations are implementing collaborative messaging applications to make work across teams more efficient. Particularly, collaborative messaging applications emphasize and enable teamwork by facilitating real-time communication and distribution of information between team members. Often, during collaborative messaging sessions between team members, different issues or tasks may arise. In such situations, it is possible that a team has multiple members capable of completing those tasks, but it is not immediately clear who is the best person to assign the job.

### SUMMARY

According to an embodiment of the present disclosure, a computer-implemented method for task assignment in a multiparticipant message exchange includes receiving, by a computer, data snapshots from a collaborative message exchange between one or more participants, based on the received data snapshots, identifying a plurality of tasks requiring completion, a task leader among the one or more participants generating the plurality of tasks, and a task criteria, based on a semantic match between the task criteria and a database of historical task completion, identifying a candidate pool for completing the plurality of tasks, determining a likelihood of each candidate in the candidate pool completing the plurality of tasks and assigning a relevancy score based on the determined likelihood, responsive to assigning the relevancy score, generating a list of ranked candidates for completing the plurality of tasks and presenting the generated list to the task leader, receiving a selection from the task leader including at least one candidate for completing the plurality of tasks, and responsive to receiving the selection, automatically notifying the selected candidate of one or more tasks to be completed and updating the database of historical task completion.

Another embodiment of the present disclosure provides a computer system for task assignment in a multiparticipant message exchange, based on the method described above.

Another embodiment of the present disclosure provides a computer program product for task assignment in a multiparticipant message exchange, based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 depicts a computer system for task assignment in a multiparticipant message exchange environment, according to an embodiment of the present disclosure;

FIG. 3A is a flowchart illustrating the steps of a computer-implemented method for task assignment in a multiparticipant message exchange environment, according to an embodiment of the present disclosure;

FIG. 3B is a continuation of the flowchart illustrating the steps of a computer-implemented method for task assignment in a multiparticipant message exchange environment, according to an embodiment of the present disclosure;

FIG. 4 is a block diagram of internal and external components of a computer system, according to an embodiment of the present disclosure;

FIG. 5 is a block diagram of an illustrative cloud computing environment, according to an embodiment of the present disclosure; and

FIG. 6 is a block diagram of functional layers of the illustrative cloud computing environment of FIG. 5, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Aspects of the present invention generally relates to the field of contextual collaboration and interaction, and more particularly to an artificial intelligence-based task assignment assistant for identifying and assigning tasks generated during a multiparticipant message exchange session.

Presently, collaborative messaging systems do not enable automatic assignment of newly opened items to appropriate participants (e.g., subject matter experts). Manual assignment (e.g., by a project manager) of an appropriate participant to a newly opened issue or task can create delays, sometimes of several days, between when a task is created and the moment it is assigned to the best person to be completed, which can delay delivery of answers to customers or stakeholders. Moreover, people within a team may know the area of expertise of each member of their team such that they can reasonably assign the best person for a particular task that needs to be completed. However, external persons (e.g., support personnel, an engineer from another team, or a direct customer) may not know the areas of expertise of team members and will often assign someone based on the title and description of the task only.

The following described exemplary embodiments provide an AI-based system, method, and computer program product to, among other things, automatically detect or identify outstanding tasks and a corresponding task criteria during a collaborative message exchange session between a plurality of participants, identify a task leader, among the participants, generating the tasks, match the tasks to a pool of optimal candidates to complete the tasks, receive a candidate selection from the task leader, monitor task completion and candidate performance, and store candidate selection and performance feedback in a knowledge base of task completion associated with the pool of candidates. In addition, the present embodiments may search a collaborative message exchange session to determine which tasks have not yet been assigned to task candidates, and based on historical information of similar tasks, assign a relevancy score according to a likelihood of an individual satisfactorily completing the tasks. Essentially, the proposed embodiments may assign a first score to the pool of candidates based on a semantic match of task criteria to previous tasks, and assign a second score to the pool of candidates that can be used to rank a candidate within the pool according to how likely they are able to resolve the new task based on historical data.

Thus, the present embodiments have the capacity to improve the technical field of contextual collaboration and interaction by automatically identifying a task to be completed and a task criterion from a collaborative message exchange, conducting a semantic match of task criteria and historical data on task completion to determine a likelihood of an individual completing the task, receiving feedback from a task leader and updating and maintaining a database of historical task completion. Additionally, the present embodiments take task similarity into account when proposing a list of task candidates to resolve a task, while capturing and considering other important metadata (i.e., worker effectiveness, workload, performance, etc.) for proposing and ranking the task candidate list. The proposed embodiments allow a task leader (e.g., the individual who opened the tasks) to choose from the task candidate list based on individual preferences or relevant criteria. For instance, the proposed system generates a task candidate ranking based on several factors, but by allowing the task leader to choose the task candidate to complete the task, the proposed system can account and learn human preferences over time.

The inclusion of human feedback may provide an augmented intelligence framework to help prevent algorithmic bias from dominating future task assignment decisions. Thus, human preferences can be used to guide future recommendations. Advantageously, the present embodiments provide a technical solution to the technical problem of automating an assignment of newly opened tasks within a computing system by automatically generating a list of candidates (e.g., subject matter experts) to complete the tasks and ranking the candidates based on past selections and past performance of each individual given a task criterion to provide the best candidate(s) to perform the tasks.

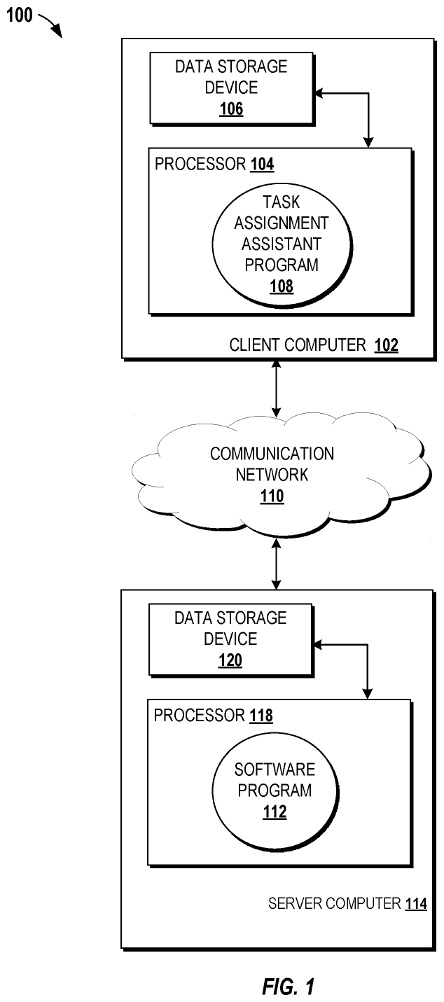

Referring now to FIG. 1, an exemplary networked computer environment 100 is depicted, according to an embodiment of the present disclosure. FIG. 1 provides only an illustration of one embodiment and does not imply any limitations with regard to the environments in which different embodiments may be implemented. Many modifications to the depicted environment may be made by those skilled in the art without departing from the scope of the invention, as recited by the claims.

The networked computer environment 100 may include a client computer 102 and a communication network 110. The client computer 102 may include a processor 104, that is enabled to run a task assignment assistant program 108, and a data storage device 106. Client computer 102 may be, for example, a mobile device, a telephone (including smartphones), a personal digital assistant, a netbook, a laptop computer, a tablet computer, a desktop computer, or any type of computing devices capable of accessing a network.

The networked computer environment 100 may also include a server computer 114 with a processor 118, that is enabled to run a software program 112, and a data storage device 120. In some embodiments, server computer 114 may be a resource management server, a web server, or any other electronic device capable of receiving and sending data via the communication network 110. In another embodiment, server computer 114 may represent a server computing system utilizing multiple computers as a server system, such as in a cloud computing environment.

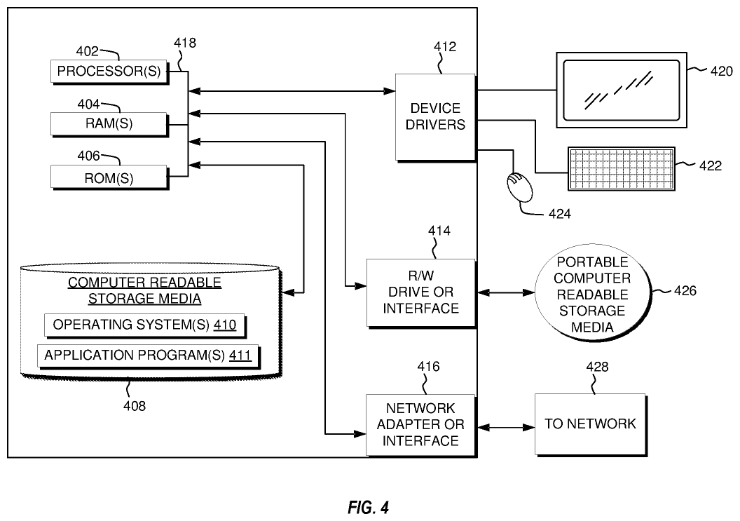

The task assignment assistant program 108 running on client computer 102 may communicate with the software program 112 running on server computer 114 via the communication network 110. As will be discussed with reference to FIG. 4, client computer 102 and server computer 114 may include internal components and external components.

The networked computer environment 100 may include a plurality of client computers 102 and server computers 114, only one of which is shown. The communication network 110 may include various types of communication networks, such as a local area network (LAN), a wide area network (WAN), such as the Internet, the public switched telephone network (PSTN), a cellular or mobile data network (e.g., wireless Internet provided by a third or fourth generation of mobile phone mobile communication), a private branch exchange (PBX), any combination thereof, or any combination of connections and protocols that will support communications between client computer 102 and server computer 114, in accordance with embodiments of the present disclosure. The communication network 110 may include wired, wireless or fiber optic connections. As known by those skilled in the art, the networked computer environment 100 may include additional computing devices, servers or other devices not shown.

Plural instances may be provided for components, operations, or structures described herein as a single instance. Boundaries between various components, operations, and data stores are somewhat arbitrary, and particular operations are illustrated in the context of specific illustrative configurations. Other allocations of functionality are envisioned and may fall within the scope of the present invention. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present invention.

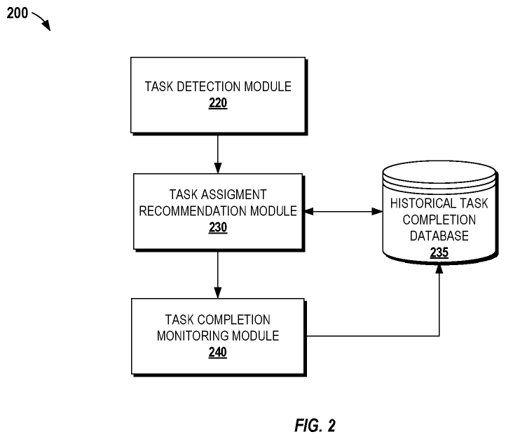

Referring now to FIG. 2, components of a computer system 200 for task assignment in a multiparticipant message exchange are shown, according to an embodiment of the present disclosure. In this embodiment, the computer system 200 includes a task detection module 220, a task assignment recommendation module 230 communicatively connected to a historical task completion database 235, and a task recommendation module 240.

In the task detection module 220, the computer system 200 aggregates multiple collaborative messaging channels and formats (e.g., email, personal or group messaging, problem ticket databases, etc.). In an embodiment, the task detection module 220 captures and stores snapshots of conversation data from a multiparticipant message thread performed on, for example, one or more of the collaborative messaging channels. Time-tagged snapshots of conversation data may allow capturing and maintaining historical data from collaborative message exchanges for report creation and analysis. The task detection module 220 uses the stored conversation data and natural language processing (NLP) algorithms to identify in the collaborative message exchange a plurality of tasks (hereinafter “tasks”) to be completed as well as a task criteria.

In one or more embodiments, the task detection module 220 can process both structured task data (e.g., from a populated tool) and unstructured text data from unstructured conversations using NLP models. For example, the task detection module 220 can process structured, labeled data in the form of tabular data from a formal problem ticket database, which can facilitate feature extraction for finding similar tasks. Additionally, the task detection module 220 can process unstructured text data from communication tools. In such cases, NLP may be used for tasks like topic modeling, semantic similarity, keyword extraction, etc., to be able to process this data and use it within the task assignment and recommendation module 230.

NLP models are typically based on machine learning (ML) algorithms. Machine learning is a form of artificial intelligence (AI) that enables a system to learn from data rather than through explicit programming. As the algorithms ingest training data, it is then possible to produce more precise models based on that data. A machine-learning model is the output generated when a machine-learning algorithm is trained with data. After training, the model is provided with an input and an output will be given to user(s). For example, a predictive algorithm will create a predictive model. Then, when users provide the predictive model with data, they will receive a prediction based on the data that trained the model.

With continued reference to FIG. 2, in one or more embodiments, the task detection module 220 is capable of identifying task owner ambiguity in the stored conversation data, i.e., tasks that are outstanding and have not been explicitly assigned by a task leader (i.e., the person requiring or assigning the tasks). For example, a new Slack™ channel or email thread is opened by Jerry. Jerry (i.e., task leader) lists a series of customer concerns on a critical account in the channel with a group of managers, team leads, and a few subject matter experts. However, Jerry does not identify who should address the customer concerns.

Accordingly, the task detection module 220 searches the collaborative message thread and identifies tasks generated by the task leader as well as a task criteria for the identified tasks. The task detection module 220 may further classify the identified tasks based on the task criteria. In an embodiment, the task criteria may include at least one of, for example, an overall task description, a completion criteria (e.g., what must be done before the task is closed), a deadline for completion (if specified by the task leader), and a potential manual owner proposal (if specified by the task leader). Particularly, a manual owner proposal refers to a proposal made by the task leader ahead of time including a recommendation of an individual to complete the task before the computer system 200 automatically proposes someone. In such instances, the computer system 200 can decide to either ignore or accept the task manager's original assignee. In another embodiment, the identified tasks can be tagged with additional metadata, such as a task category, to enable high quality or more accurate matches by the task assignment recommendation module 230.

Once the task detection module 220 identifies the tasks to be completed, the task assignment recommendation module 230 performs a semantic matching based on the task criteria and related tasks from the historical task completion database 235 to select a pool of candidates for performing the tasks. For example, the task detection module 220 can access a company directory and identify individuals reporting to managers in the original chat thread started by Jerry (task leader). The task detection module 220, using the historical task completion database 235, may identify one or more of those individuals as task candidates based on stored information including, for example, area of expertise, past performance, past selection to complete a related task, etc. In an embodiment, the task assignment recommendation module 230 may assign a first score to each candidate in the candidate pool based on the semantic match of task criteria and the history of related tasks. In some embodiments, the task assignment recommendation module 230 may further refine the task candidate pool by searching (external) databases associated with subject matter expert candidates and recording search results in the historical task completion database 235.

Accordingly, the task assignment recommendation module 230 based on the performed semantic match on previously completed tasks can determine whether one or more candidates in the pool of task candidates have worked on similar tasks in the past. The historical task completion database 235 may be maintained by the task assignment recommendation module 230 or may function in cooperation with existing project management software.

It should be noted that the task assignment recommendation module 230 may allow users of the computer system 200 to define and configure a match threshold for past task relevancy. Candidates that are not associated with a past task data above the relevancy/semantic match threshold can be removed from the selection pool used by the task assignment recommendation module 230 to further rank candidates. The task assignment recommendation module 230 may also allow users of the computer system 200 to define and configure a snapshot time frame window that can be used to associate task candidates with newly generated tasks. This may allow task leaders (e.g., Jerry) to ignore results potentially based on outdated data.

More particularly, decreasing task relevancy may cause the computer system 200 to have more candidates to potentially evaluate, and specifying a time frame window may allow the computer system 200 to exclude certain results made based on stale (old) data (since data is stored incrementally at point in time intervals). This may allow the task assignment recommendation module 230 to be more selective with the data used by the task assignment model to make the recommendations based on the time frame of the data. For example, the task assignment model may be trained on data over 10 years, or just over the past two months. It should be noted that timestamps are associated with the storage of records in the historical task completion database 235.

According to an embodiment, the task assignment recommendation module 230 may further determine a likelihood of an individual completing the identified tasks (i.e., solving the problem). The individual (e.g., team member) most likely to satisfactorily complete the identified tasks becomes a task candidate. In some embodiments, the task assignment recommendation module 230 may retrieve information from the historical task completion database 235 including an average completion time of the task candidate for finishing a related task (i.e., a task previously performed by the task candidate that is similar to the task to be performed) as well as a total workload of the task candidate. In an embodiment, the likelihood of a task candidate completing a task can include a semantic similarity score weighting when ranking candidates. In such embodiment, a likelihood function may be computed from a weighted score using, at least in part, the features of task relevancy, working pace, availability, and other task characteristics that may facilitate best meeting the task criteria.

In one embodiment, the task assignment recommendation module 230 uses a sliding window of sentiment analysis to monitor individual interactions between task candidates working on an issue and task leaders. If the task leader provides positive feedback in response to actions taken by the task candidate, then the task candidate is identified as being more valuable in resolving the task. This information can be stored in the historical task completion database 235. The aggregated sentiment analysis score across related tasks may be used by the task assignment recommendation module 230 to rank potential candidates for the new task, as will be described below.

In another embodiment, the task assignment recommendation module 230 may keep track of how many related tasks were assigned to a task candidate (workload) and the completion time of those related tasks to avoid overloading key task candidates. By doing this, the computer system 200 may learn which features (e.g., task relevancy, sentiment analysis score, task load, etc.) contribute to the best task outcome.

The above factors contribute and are taking into account to determine the likelihood of a task candidate completing a task. In an embodiment, the task assignment recommendation module 230 may assign a second score to each candidate in the candidate pool based on the likelihood of each candidate successfully completing the tasks identified by the task detection module 220. It should be noted that the first score based on task relevancy and semantic similarity can be used to compute the second score.

Thus, based on the first score and the second score, the task assignment recommendation module 230 selects and ranks task candidates (e.g., chat participants, team members, subject matter experts) and generates a list of ranked candidates.

It should be noted that, in some embodiments, the task candidate may not be participating in the collaborative message exchange. For example, a potential task candidate may belong to a different team or be in a different geographic location, but may be selected based on an area of expertise or past performance completing a related task.

The computer system 200, via the task assignment recommendation module 230, provides the list of ranked task candidates (e.g., via a user-interface) to the task leader and allows the task leader to filter candidate choices by various metrics including a time frame of data used. For instance, the task leader may discard matches based on data older than 5 years. It should be noted that the inclusion of human feedback may provide an augmented intelligence framework to help prevent algorithmic bias from dominating future task assignment decisions.

After the task assignment recommendation module 230 receives a selection of a task candidate for completing the one or more tasks, a notification is automatically generated and sent to the selected task candidate (e.g., Jerry confirms the recommendation provided by the task assignment recommendation module 230, and the selected task candidate receives a direct message in their inbox). Then, the task completion monitoring module 240 may supervise task execution and completion by the selected task candidate. For example, the task completion monitoring module 240 monitors collaborative message exchange between members of an original message exchange (e.g., the original chat started by Jerry) to determine whether the task completion criteria have been satisfied.

In an embodiment, after completing the tasks, the task completion monitoring module 240 may prompt a task leader to provide feedback on the task candidate performance. The task completion and monitoring module 240 may record such feedback and update the historical task completion database 235 for future task assignments. Thus, the task completing monitoring module 240 can use feedback data to infer which task candidate in the generated candidate pool was the most efficient in completing the identified tasks (i.e., moving the solution forward) and store such information in the historical task completion database 235 for future use.

It should be noted that data collection (e.g., from email, collaborative messaging applications, etc.) is done with user(s) consent via, for example, an opt-in and opt-out feature. The user(s) can choose to stop having his/her information being collected or used. In some embodiments, user(s) can be notified each time data is being collected. The collected data is envisioned to be secured and not shared with anyone without previous consent. User(s) can stop data collection at any time.

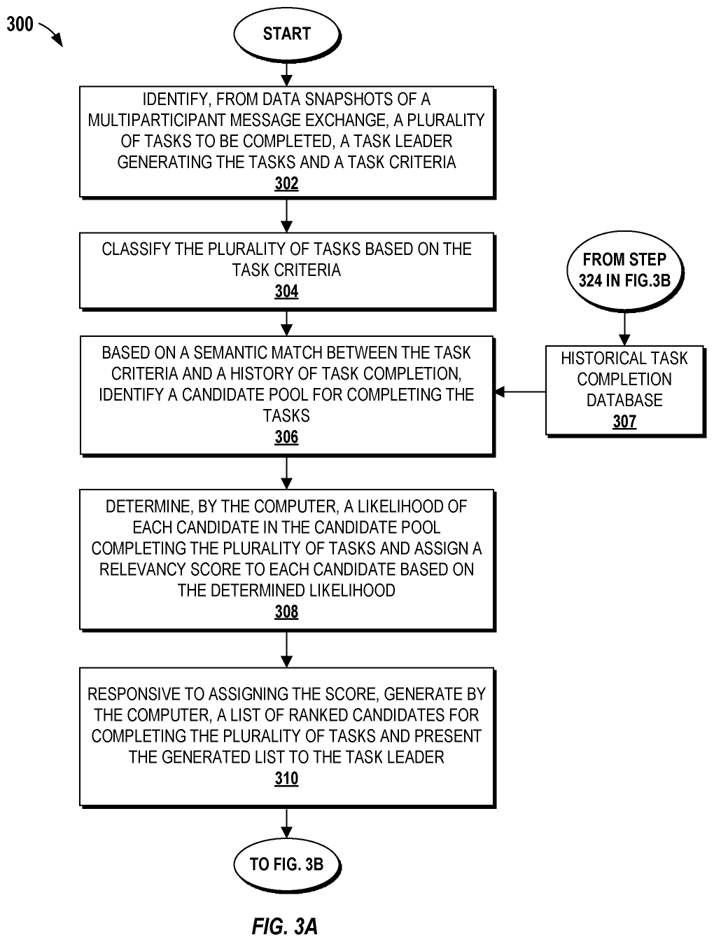

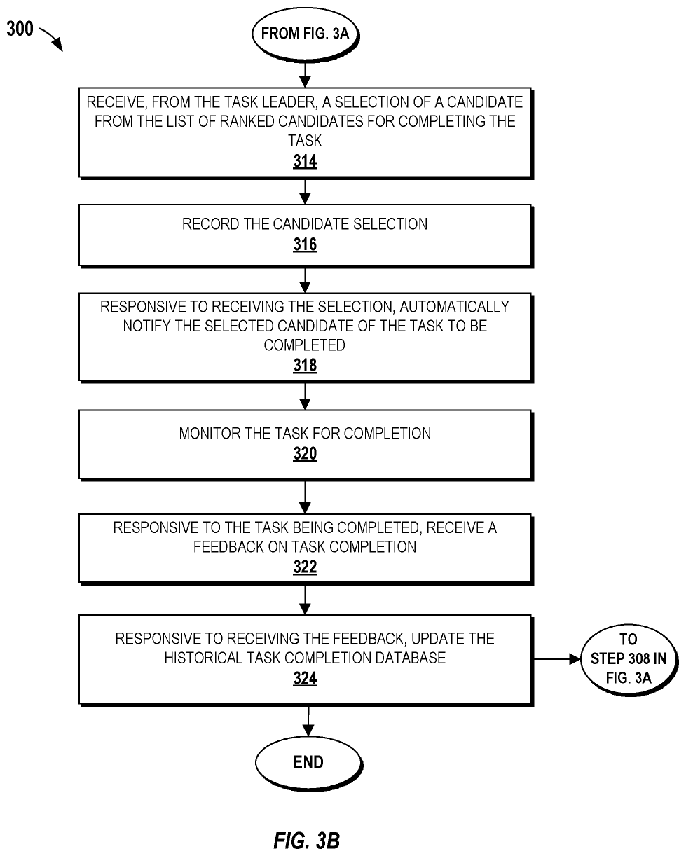

Referring now to FIGS. 3A-3B, a flowchart 300 illustrating the steps of a computer-implemented method for automatic task assignment in a multiparticipant message exchange is shown, according to an embodiment of the present disclosure.

The method starts at step 302 by identifying a plurality of tasks, a task leader generating the tasks and a task criteria from a multiparticipant message exchange. In this step, snapshots of conversation data from a multiparticipant message thread can be capture and store from multiple collaborative messaging platforms. NLP algorithms are used to identify the tasks to be completed as well as the task criteria. In one or more embodiments, structured task data and unstructured text data can be processed to identify the plurality of tasks and task criteria. In some embodiment, the identified tasks may include outstanding tasks that have not been explicitly assigned by the task leader.

At step 304, the plurality of tasks identified at step 302 can be classified according to the task criteria. As mentioned above, the task criteria may include, for example, an overall task description, a completion criteria, a deadline for completion, etc. In some embodiments, the identified tasks can be tagged with additional metadata, such as a task category, that can also be used to classify the tasks and perform more accurate task assignments.

At step 306, based on a semantic match between the task criteria and a history of task completion, a candidate pool including a plurality of individuals capable of satisfactorily completing one or more of the plurality of tasks can be identified. The history of task completion may be retrieved from a knowledge base of related task completion and past performance associated with the candidate pool (e.g., the historical task completion database 307). The historical task completion database 307 may include, for example, a company directory.

In one or more embodiments, the task leader can filter candidate choices by various metrics including, for example, a time frame of data used. In some embodiments, the task leader can filter candidate choices by candidate availability. In such embodiments, the task assignment recommendation module 230 (FIG. 2) can be extended to work with the task completion monitoring module 240 (FIG. 2) to query if the candidates being proposed are already involved with other outstanding tasks.

The process continues at step 308 by determining a likelihood of each candidate in the candidate pool completing the tasks and assigning a relevancy score to each candidate based on the determined likelihood. As described above, according to an embodiment the likelihood of a task candidate completing a task can include a semantic similarity score weighting when ranking candidates. In such embodiment, a likelihood function may be computed from a weighted score using, at least in part, the features of task relevancy, working pace, availability, and other task characteristics that may facilitate best meeting the task criteria.

In some embodiments, a sliding window of sentiment analysis can be used to monitor individual interactions between task candidates and task leaders and determine which candidate is more valuable in resolving the task. In such instances, the relevancy score can be assigned based on the aggregated sentiment analysis across related tasks.

Responsive to assigning the relevancy score, at step 310, a list of ranked candidates for completing the plurality of tasks can be generated and presented to the task leader. The list of ranked candidates for completing the task can be presented via, for example, a user-interface.

At step 314, the selection including a candidate from the list of ranked candidates for completing the task is received by the computer system 200 (FIG. 2). The selection is recorded at step 316. In some embodiments, the candidate selection is recorded in the historical task completion database 307. Responsive to receiving the selection, at step 318, a notification including the task to be completed is automatically sent to the selected candidate.

At step 320, the computer system 200 (FIG. 2) monitors execution of the tasks and task completion by, for example, monitoring collaborative message exchange between the task leader and team members. After the tasks have been completed, the computer system 200 (FIG. 2) may prompt the task leader for feedback on task completion. In response to receiving the feedback from the task leader, the computer system 200 (FIG. 2) updates the historical task completion database 307 to include the feedback associated with the selected task candidate performance and ends the process.

By allowing the task leader to choose a candidate to complete the task and provide performance feedback, individual preferences can be learned over time and used to continuously augment the historical task completion database 307 and improve predictive models, which in turn may help performing more accurate task assignments.

Referring now to FIG. 4, a block diagram of components of client computer 102 and server computer 114 of networked computer environment 100 of FIG. 1 is shown, according to an embodiment of the present disclosure. It should be appreciated that FIG. 4 provides only an illustration of one implementation and does not imply any limitations regarding the environments in which different embodiments may be implemented. Many modifications to the depicted environment may be made.

Client computer 102 and server computer 114 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411 are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Client computer 102 and server computer 114 may also include a R/W drive or interface 414 to read from and write to one or more portable computer readable storage media 426. Application programs 411 on client computer 102 and server computer 114 may be stored on one or more of the portable computer readable storage media 426, read via the respective RAY drive or interface 414 and loaded into the respective computer readable storage media 408.

Client computer 102 and server computer 114 may also include a network adapter or interface 416, such as a TCP/IP adapter card or wireless communication adapter (such as a 4G wireless communication adapter using OFDMA technology) for connection to a network 428. Application programs 411 on client computer 102 and server computer 114 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Client computer 102 and server computer 114 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may include hardware and software (stored on computer readable storage media 408 and/or ROM 406).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

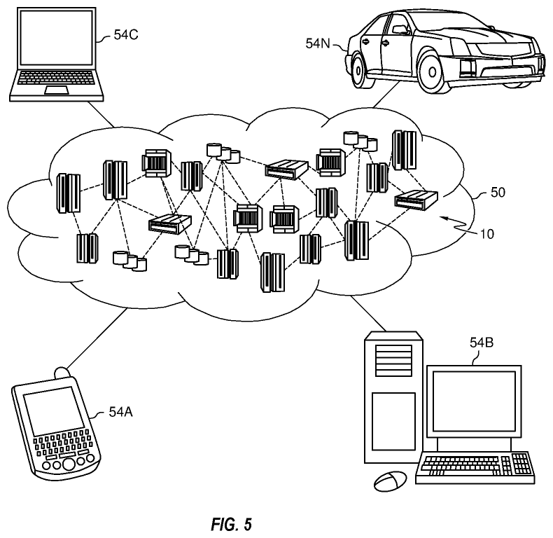

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

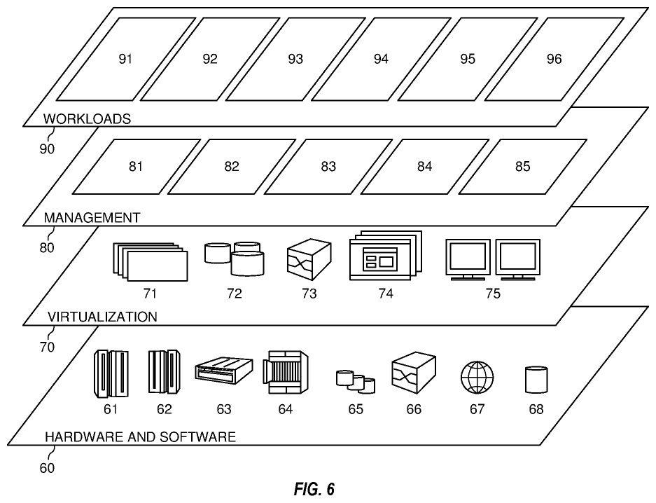

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and intelligent system for task assignment 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for task assignment in a multiparticipant message exchange, comprising:
receiving, by a computer, data snapshots from a collaborative message exchange between one or more participants;
based on the received data snapshots, identifying, by the computer, a plurality of tasks requiring completion, a task leader among the one or more participants generating the plurality of tasks, and a task criteria;
based on a semantic match between the task criteria and a database of historical task completion, identifying, by the computer, a candidate pool for completing the plurality of tasks;
determining, by the computer, a likelihood of each candidate in the candidate pool completing the plurality of tasks and assigning a relevancy score based on the determined likelihood;
responsive to assigning the relevancy score, generating, by the computer, a list of ranked candidates for completing the plurality of tasks and presenting the generated list to the task leader;
receiving, by the computer, a selection from the task leader including at least one candidate for completing the plurality of tasks; and
responsive to receiving the selection, automatically notifying the selected candidate of one or more tasks to be completed and updating the database of historical task completion.

2. The method of claim 1, further comprising:
monitoring, by the computer, the plurality of tasks for completion;
responsive to the plurality of tasks being completed, receiving, by the computer a feedback on task completion; and
responsive to receiving the feedback, updating, by the computer, the historical task completion database.

3. The method of claim 1, further comprising:
aggregating, by the computer, multiple channels and formats of information for capturing the data snapshots, the data snapshots comprising time-tagged data.

4. The method of claim 1, further comprising:
identifying, by the computer, a task ambiguity associated with one or more outstanding tasks not being assigned to a candidate in the candidate pool.

5. The method of claim 1, wherein determining the likelihood further comprises:
computing, by the computer, a likelihood function from a weighted score using, at least in part, features associated with each candidate including a task relevancy, a working pace, and an availability.

6. The method of claim 1, further comprising:
using, by the computer, a sliding window of sentiment analysis for monitoring a performance of the at least one candidate on a related task; and
determining, by the computer, a sentiment analysis score across related tasks to rank candidates in the candidate pool for completing the plurality of tasks.

7. The method of claim 1, wherein the task criteria comprises at least one of an overall task description, a completion criteria, a deadline for completion, and a potential manual owner proposal.

8. The method of claim 1, wherein the plurality of tasks are tagged with additional metadata including a task category to enable accurate candidate matches.

9. A computer system for task assignment in a multiparticipant message exchange, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving, by a computer, data snapshots from a collaborative message exchange between one or more participants;
based on the received data snapshots, identifying, by the computer, a plurality of tasks requiring completion, a task leader among the one or more participants generating the plurality of tasks, and a task criteria;
based on a semantic match between the task criteria and a database of historical task completion, identifying, by the computer, a candidate pool for completing the plurality of tasks;
determining, by the computer, a likelihood of each candidate in the candidate pool completing the plurality of tasks and assigning a relevancy score based on the determined likelihood;
responsive to assigning the relevancy score, generating, by the computer, a list of ranked candidates for completing the plurality of tasks and presenting the generated list to the task leader;
receiving, by the computer, a selection from the task leader including at least one candidate for completing the plurality of tasks; and
responsive to receiving the selection, automatically notifying the selected candidate of one or more tasks to be completed and updating the database of historical task completion.

10. The computer system of claim 9, further comprising:
monitoring, by the computer, the plurality of tasks for completion;
responsive to the plurality of tasks being completed, receiving, by the computer a feedback on task completion; and
responsive to receiving the feedback, updating, by the computer, the historical task completion database.

11. The computer system of claim 9, further comprising:
aggregating, by the computer, multiple channels and formats of information for capturing the data snapshots, the data snapshots comprising time-tagged data.

12. The computer system of claim 9, further comprising:
identifying, by the computer, a task ambiguity associated with one or more outstanding tasks not being assigned to a candidate in the candidate pool.

13. The computer system of claim 9, wherein determining the likelihood further comprises:
computing, by the computer, a likelihood function from a weighted score using, at least in part, features associated with each candidate including a task relevancy, a working pace, and an availability.

14. The computer system of claim 9, further comprising:
using, by the computer, a sliding window of sentiment analysis for monitoring a performance of the at least one candidate on a related task; and
determining, by the computer, a sentiment analysis score across related tasks to rank candidates in the candidate pool for completing the plurality of tasks.

15. The computer system of claim 9, wherein the task criteria comprises at least one of an overall task description, a completion criteria, a deadline for completion, and a potential manual owner proposal.

16. The computer system of claim 9, wherein the plurality of tasks are tagged with additional metadata including a task category to enable accurate candidate matches.

17. A computer program product for task assignment in a multiparticipant message exchange, comprising:
one or more computer readable storage media, and program instructions collectively stored on the one or more computer readable storage media, the program instructions comprising:
program instructions to receive, by a computer, data snapshots from a collaborative message exchange between one or more participants;
based on the received data snapshots, program instructions to identify, by the computer, a plurality of tasks requiring completion, a task leader among the one or more participants generating the plurality of tasks, and a task criteria;
based on a semantic match between the task criteria and a database of historical task completion, program instructions to identify, by the computer, a candidate pool for completing the plurality of tasks;
program instructions to determine, by the computer, a likelihood of each candidate in the candidate pool completing the plurality of tasks and assigning a relevancy score based on the determined likelihood;
responsive to assigning the relevancy score, program instructions to generate, by the computer, a list of ranked candidates for completing the plurality of tasks and presenting the generated list to the task leader;
program instructions to receive, by the computer, a selection from the task leader including at least one candidate for completing the plurality of tasks; and
responsive to receiving the selection, program instructions to automatically notify the selected candidate of one or more tasks to be completed and updating the database of historical task completion.

18. The computer program product of claim 17, further comprising:
program instructions to monitor, by the computer, the plurality of tasks for completion;
responsive to the plurality of tasks being completed, program instructions to receive, by the computer a feedback on task completion; and
responsive to receiving the feedback, program instructions to update, by the computer, the historical task completion database.

19. The computer program product of claim 17, further comprising:
program instructions to aggregate, by the computer, multiple channels and formats of information for capturing the data snapshots, the data snapshots comprising time-tagged data.

20. The computer program product of claim 17, wherein the program instructions to determine the likelihood further comprise:
program instructions to compute, by the computer, a likelihood function from a weighted score using, at least in part, features associated with each candidate including a task relevancy, a working pace, and an availability.
